(19) United States
(12) Patent Application Publication
(10) Pub. No.: US 2026/0116063 A1
(43) Pub. Date: Apr. 30, 2026

(54) LAMINATING DEVICE, IMAGE FORMING SYSTEM, AND STORAGE MEDIUM

(71) Applicant: Konica Minolta, Inc., Tokyo (JP)

(72) Inventor: Yuta Okuno, Tokyo (JP)

(73) Assignee: Konica Minolta, Inc., Tokyo (JP)

(21) Appl. No.: 19/373,064

(22) Filed: Oct. 29, 2025

(30) Foreign Application Priority Data
Oct. 30, 2024 (JP) 2024190201

(51) Int. Cl. B32B 41/00; B32B 38/00; G03G 15/00

(52) U.S. Cl. CPC B32B 41/00; B32B 38/145; G03G 15/6573; G03G 15/6582; G03G 2215/00556; G03G 2215/00717; G03G 2215/00789; G03G 2215/00945

(57) ABSTRACT

A laminating device including: a laminator that performs lamination processing of laminating a film on a recording medium on which image formation has been performed; and a first hardware processor that: acquires sheet characteristic information corresponding to smoothness of the recording medium; and controls a conveyance speed in the laminator based on the acquired sheet characteristic information.

### CROSS-REFERENCE TO RELATED APPLICATIONS

The entire disclosure of Japanese Patent Application No. 2024-190201 filed on Oct. 30, 2024 is incorporated herein by reference in its entirety.

### BACKGROUND OF THE INVENTION

### Technical Field

The present disclosure relates to a laminating device, an image forming system, and a storage medium.

### Description of Related Art

In the related art, in a manufacturing process of covering a printed material which is a recording medium with a transparent resin film (laminate film), a printing processing apparatus which integrates all steps from printing to lamination processing is known.

By integrating all the steps from the printing to the laminating (lamination processing) in such a printing and processing apparatus, manpower required for each step can be reduced, and all the steps from the printing to the laminating can be completed by automatic operation.

In this regard, Japanese Unexamined Patent Publication No. 2023-60910 describes an image forming system in which processing pressures, processing temperatures, and the like that are conditions for lamination are determined on the basis of information on image formation by an image forming section.

### SUMMARY OF THE INVENTION

However, in the invention described in Japanese Unexamined Patent Publication No. 2023-60910, when lamination is performed under lamination conditions determined on the basis of information on image formation, air bubble may enter between the laminate film and the recording medium.

An object of the present disclosure is to provide a laminating device, an image forming system, and a storage medium capable of performing a laminating process with high quality.

To achieve at least one of the abovementioned objects, according to an aspect of the present invention, laminating device reflecting one aspect of the present invention comprises:
a laminator that performs lamination processing of laminating a film on a recording medium on which image formation has been performed; and
a first hardware processor that:
acquires sheet characteristic information corresponding to smoothness of the recording medium; and
controls a conveyance speed in the laminator based on the acquired sheet characteristic information.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a front view illustrating a schematic configuration of an image forming system according to the present embodiment;

FIG. 2 is a functional block diagram illustrating a control structure of the image forming system according to the present embodiment;

FIG. 3 is a diagram illustrating an example of a conveyance speed table;

FIG. 4 is a flowchart illustrating a flow of lamination control processing;

FIG. 5 is a flowchart illustrating a flow of sheet conveyance control processing;

FIG. 6 is a flowchart illustrating a flow of lamination control processing of a modification example; and

FIG. 7 is a diagram illustrating an example of a conveyance speed table that stores sheet conveyance speeds after adjustment.

### DETAILED DESCRIPTION

Hereinafter, one or more embodiments of the present invention will be described with reference to the drawings. However, the scope of the invention is not limited to the disclosed embodiments.

### 1. CONFIGURATION OF IMAGE FORMING SYSTEM

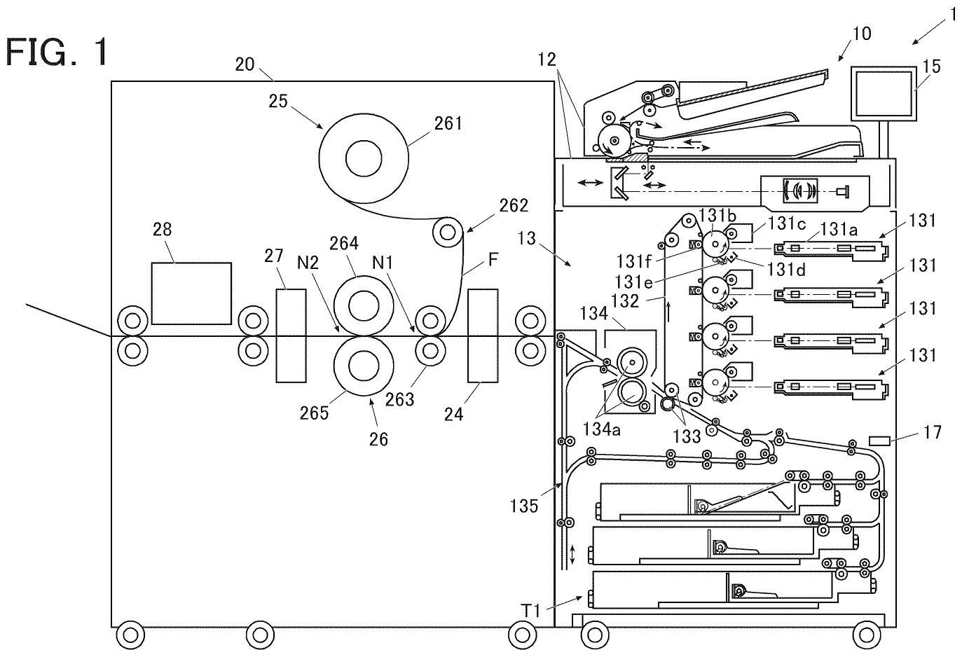

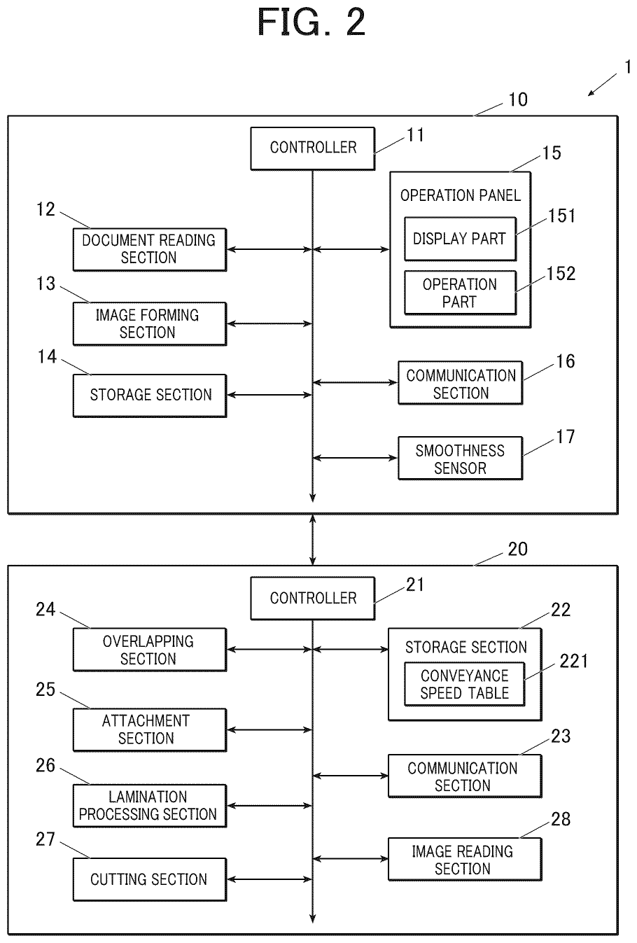

As illustrated in FIGS. 1 and 2, the image forming system 1 according to the present embodiment includes an image forming apparatus 10 and a laminating device 20.

### (1-1. Configuration of Image Forming Apparatus)

As illustrated in FIGS. 1 and 2, the image forming apparatus 10 includes a controller 11 (second hardware processor), a document reading section 12, an image forming section 13 (image former), a storage section 14, an operation panel 15, a communication section 16, a smoothness sensor 17, and the like.

The operation panel 15 includes a display part 151 that displays various kinds of information for the user and an operation part 152 that receives operations input by the user.

The controller 11 includes a central processing unit (CPU), a random access memory (RAM), a read only memory (ROM), and the like.

In response to an operation signal input from the operation part 152 or an instruction signal received by the communication section 16, the CPU reads various program stored in the ROM and develops them in the RAM.

Then, the CPU centrally controls operation of the image forming apparatus 10 in cooperation with various programs loaded in the RAM.

The document reading section 12 scans and exposes an image of a document placed on a document plate or an auto document feeder (ADF) (not illustrated) by an optical system of a scanning exposure device. Next, the document reading section 12 reads the reflected light of the scanning exposure by the line image sensor, thereby obtaining an image signal.

Next, the document reading section 12 performs processing, such as A/D conversion, shading correction, and compression, on the image signal, and then outputs the image signal as image data to the controller 11.

In addition to the image data read by the document reading section 12, the controller 11 acquires, for example, image data included in a print job received from an external device (not illustrated) via the communication section 16.

The image forming section 13 forms an image of four colors of C, M, Y, and K on a sheet, according to the pixel values of the four colors of each pixel of the original image subjected to image processing.

As illustrated in FIG. 1, the image forming section 13 includes four writing sections 131, an intermediate transfer belt 132, a secondary transfer roller 133, and a fixing section 134.

Four writing sections 131 are arranged in series (tandem) along the belt plane of the intermediate transfer belt 132 to form images in C, M, Y and K colors. The writing sections 131 have the same configuration except for the color of an image to be formed, and include optical scanning sections 131a, photoreceptors 131b, developing sections 131c, charging sections 131d, cleaning sections 131e, and primary transfer rollers 131f.

Each writing section 131 charges the photoreceptor 131b with the charging section 131d, and then scans the photoreceptor 131b with a light flux emitted from the optical scanning section 131a based on the original image to form an electrostatic latent image. Next, each writing section 131 supplies a color material such as a toner by the developing section 131c to develop the electrostatic latent image, thereby forming an image on the photoreceptor 131b.

Next, the writing sections 131 then sequentially transfer the images formed on the four photoreceptors 131b to the intermediate transfer belt 132 using the primary transfer rollers 131f so that the images overlap (primary transfer). Thus, the writing section 131 forms an image of each color on the intermediate transfer belt 132.

The intermediate transfer belt 132 is an image bearing member that rotates by being wound around a plurality of rollers.

After the primary transfer, the cleaning section 131e removes the color material remaining on the photoreceptor 131b.

The image forming section 13 feeds a sheet from a sheet feed tray T1 in accordance with the timing at which the image on the rotating intermediate transfer belt 132 reaches the position of the secondary transfer roller 133. In the present embodiment, the sheet is a flat cut sheet.

One of the paired secondary transfer rollers 133 is pressed against the intermediate transfer belt 132, and the other is one of a plurality of rollers around which the intermediate transfer belt 132 is wound.

The secondary transfer roller 133 transfers (secondarily transfers) the image from the intermediate transfer belt 132 onto a sheet by pressure contact with the intermediate transfer belt 132.

Next, the image forming section 13 conveys the sheet after the second transfer to the fixing section 134.

The fixing section 134 performs fixing processing in which the fixing roller 134a applies heat and pressure to the sheet to fix the image on the sheet.

In the case of single-sided printing in which an image is formed on only one side of the sheet, the image forming section 13 conveys the sheet after the fixing processing to the laminating device 20.

In double-sided printing in which images are formed on both sides of a sheet, the image forming section 13 conveys the sheet after fixing to a reverse path 135 to reverse the sheet surface, and then feeds the sheet again to a position upstream of the secondary transfer roller 133 in the sheet conveyance route.

The storage section 14 is a nonvolatile storage device including a hard disk drive (HDD), a solid state drive (SSD), and the like.

The storage section 14 stores various programs, various setting data, and the like in a readable and writable manner from the controller 11.

The display part 151 includes a color liquid crystal display and the like, and displays a display screen according to a display control signal input from the controller 11. The display screen includes various setting screens, a screen including various buttons, a screen including an operating status of each function, and the like.

The operation part 152 includes a touch screen laid on the screen of the display part 151 and various hard keys arranged near the screen of the display part 151.

The operation part 152 outputs, to the controller 11, a signal based on the user operation.

The communication section 16 is an interface that connects the image forming apparatus 10 to a communication network, and includes a communication integrated circuit (IC) and a communication connector.

Under the control of the controller 11, the communication section 16 transmits and receives various kinds of information to and from an external device connected to the network according to a predetermined communication protocol.

The smoothness sensor 17 is disposed, for example, upstream from the image forming section 13 on the sheet conveyance route.

The smoothness sensor 17 is a reflective optical sensor and detects the smoothness of the sheet by detecting specular reflection light and diffuse reflection light from the surface of the sheet, and outputs the detection result to the controller 11.

### (1-2. Configuration of Laminating Device)

The laminating device 20 laminates (performs lamination processing to) a sheet (recording medium) on which an image has been formed by the image forming apparatus 10.

The laminating device 20 includes a controller 21 (first hardware processor), a storage section 22, a communication section 23, an overlapping section 24, a attachment section 25, a lamination processing section 26 (laminator), a cutting section 27, an image reading section 28, and the like.

The controller 21 includes a CPU, a RAM, a ROM, and the like. In response to an instruction signal received by the communication section 23, the CPU reads various program stored in the ROM and develops them in the RAM. Next, the CPU integrally controls the operation of the laminating device 20 in cooperation with the various programs developed in the RAM.

The storage section 22 is a non-volatile storage device including an HDD and an SSD.

The storage section 22 stores various programs, various setting data, and the like in a readable and writable manner from the controller 21.

The storage section 22 stores a conveyance speed table 221.

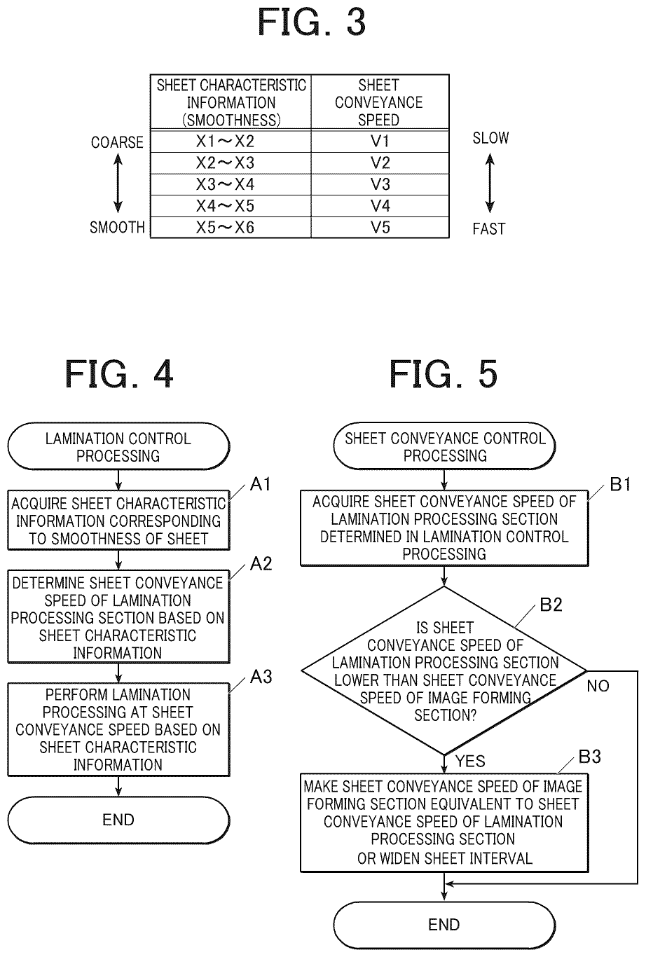

FIG. 3 shows an example of the conveyance speed table 221.

As illustrated in FIG. 3, the conveyance speed table 221 stores the correspondence relationship between sheet characteristic information corresponding to the smoothness of the sheet and the sheet conveyance speed in the lamination processing section 26.

The value of the sheet characteristic information indicates that the smoothness of the sheet is lower and the sheet surface is rougher as the value is closer to X1, and the smoothness of the sheet is higher and the sheet surface is smoother as the value is closer to X6.

The value of the sheet conveyance speed in the lamination processing section 26 indicates that the speed is lower as the position is closer to the VI and the speed is higher as the position is closer to the V5.

That is, the correspondence relationship between the sheet characteristic information corresponding to the smoothness of the sheet and the sheet conveyance speed in the lamination processing section 26 indicates that the lower the smoothness of the sheet, the slower the sheet conveyance speed in the lamination processing section 26.

The communication section 23 is an interface that connects the laminating device 20 to a network, and includes a communication IC, a communication connector, and the like.

The communication section 23, under the control of the controller 21, transmits and receives various information to and from an external device connected to the network using a predetermined communication protocol.

As shown in FIG. 1, the overlapping section 24 is provided upstream of the lamination processing section 26 in the sheet conveyance route.

An overlapping section 24 overlaps the rear end part of a preceding sheet onto the upper part of the front end part of a succeeding sheet by a predetermined superimpose amount and conveys the sheets in a continuous belt shape.

The attachment section 25 is configured such that a film roll 261 of the film F, which is a laminate film, can be attached thereto.

The attachment section 25 may be capable of mounting a plurality of film rolls 261.

The lamination processing section 26 performs lamination processing, in which a film F is continuously bonded to one side of the sheets overlapped by the overlapping section 24.

The lamination processing section 26 includes a film roll 261, a film conveyance route 262, a bonding section 263, a heating roller 264, and a pressure roller 265.

The film roll 261 is formed of two layers of film F in a roll shape.

The film F is composed of a transparent resin film layer and an adhesive layer.

The film conveyance route 262 conveys the film F from the film roll 261 to the nip portion N1 of the bonding section 263.

As illustrated in FIG. 1, the bonding section 263 includes two rollers.

The bonding section 263 sandwiches the sheet and the film F in the nip portion N1 formed by the two rollers, thereby bonding the adhesive layer of the film F to the surface of the sheet. Thus, the bonding section 263 bonds the sheet and the film F together.

The heating roller 264 includes a heating means such as a halogen heater.

The pressure roller 265 is pressed against the heating roller 264 by being biased upward by a bias member (not shown) such as a spring.

The heating roller 264 and the pressure roller 265 are in surface contact with each other to form a nip portion N2.

The heating roller 264 and the pressure roller 265 melt the adhesive layer of the film F in the nip portion N2, and bond the melted adhesive layer to the surface of the sheet to bond them together by thermocompression bonding.

The cutting section 27 inserts a cutting blade between the sheets overlapped by the overlapping section 24 to cut only the film F and separation the sheets from each other.

The image reading section 28 includes, for example, a color scanner.

The image reading section 28 reads the laminated sheet and outputs read image data to the controller 21.

### 2. OPERATION OF IMAGE FORMING SYSTEM

Next, the operation of the image forming system 1 according to the present embodiment will be described.

FIG. 4 is a flowchart showing a sequence of a lamination control processing executed by the laminating device 20.

The laminating device 20 executes lamination control processing, triggered by the image forming apparatus 10 acquiring job information of a print job including lamination processing via the communication section 16 or the operation part 152 and an instruction to execute lamination processing being given by the controller 11.

### (Lamination Control Processing)

The controller 21 of the laminating device 20 acquires the sheet characteristic information, which is the detection result of the target sheet of the print job by the smoothness sensor 17, from the image forming apparatus 10 via the communication section 23 (step A1). The controller 21 functions as an acquisition section.

Next, the controller 21 acquires, from the conveyance speed table 221, the sheet conveyance speed in the lamination processing section 26 corresponding to the sheet characteristic information acquired in step A1. Based on the sheet characteristic information acquired in step A1, the controller 21 may calculate the sheet conveyance speed in the lamination processing section 26 by a calculation formula.

Next, the controller 21 determines the acquired sheet conveyance speed as a processing condition in the lamination processing (step A2). That is, the controller 21 controls the sheet conveyance speed in the lamination processing section 26 based on the sheet characteristic information. The controller 21 functions as a first controller.

Next, the controller 21 sets the processing conditions determined in step A2 for the lamination processing section 26, performs lamination processing on the sheet conveyed from the image forming apparatus 10 (step A3), and ends the lamination control processing.

Next, the sheet conveyance control processing (see FIG. 5) executed by the image forming apparatus 10 will be described.

The image forming apparatus 10 executes the sheet conveyance control processing with acquisition of job information of a print job including lamination processing via the communication section 16 or the operation part 152 as a trigger.

### (Sheet Conveyance Control Processing)

The controller 11 of the image forming apparatus 10 acquires the sheet conveyance speed in the lamination processing section 26 determined in step A2 of the lamination control processing from the laminating device 20 via the communication section 16 (step B1).

Next, the controller 11 determines whether or not the sheet conveyance speed in the lamination processing section 26 acquired in step B1 is lower than the sheet conveyance speed in the image forming section 13 (step B2).

When the sheet conveyance speed of the lamination processing section 26 is not lower than the sheet conveyance speed of the image forming section 13 (step B2; NO), the controller 11 ends the sheet conveyance control processing.

On the other hand, when the sheet conveyance speed of the lamination processing section 26 is lower than the sheet conveyance speed of the image forming section 13 (step B2; YES), the controller 11 sets the sheet conveyance speed of the image forming section 13 to be equivalent to the sheet conveyance speed of the lamination processing section 26. Alternatively, the controller 11 widens the conveyance interval of sheets in the image forming apparatus 10 from the currently set interval (step B3). The controller 11 functions as a second controller. Next, the controller 11 ends the sheet conveyance control processing.

### 3. MODIFICATION EXAMPLE

Next, modification example of the above-described embodiment will be described. Hereinafter, differences from the above embodiment will be mainly described.

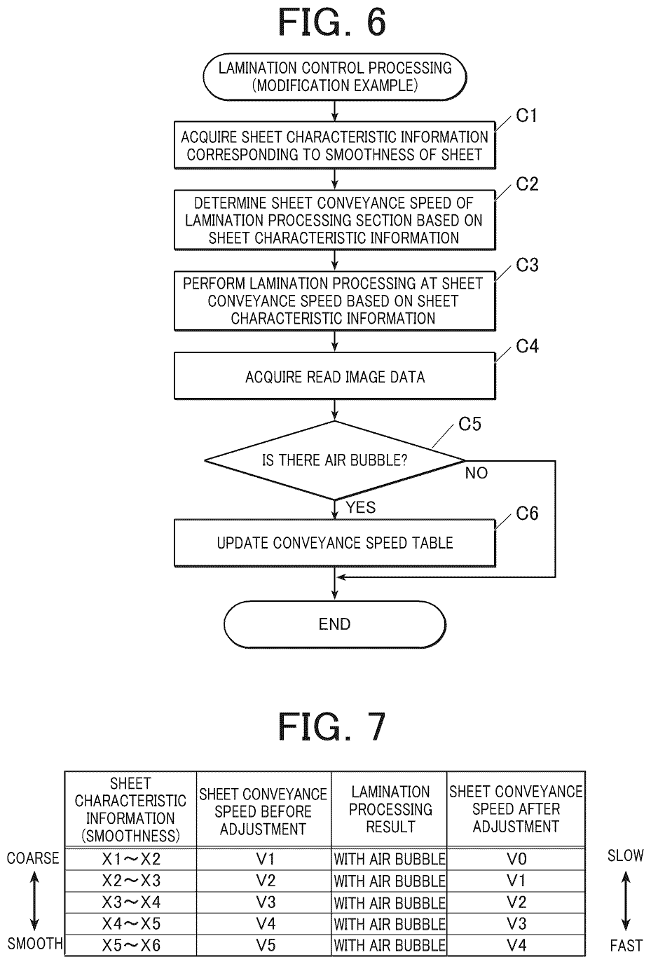

FIG. 6 is a flowchart illustrating a flow of lamination control processing of a modification example.

### (Lamination Control Processing in Modification Example)

The controller 21 of the laminating device 20 executes steps Cl to C3 similar to steps A1 to A3 of the lamination control processing of the above-described embodiment.

Next, the controller 21 causes the image reading section 28 to read the sheet subjected to the lamination processing in step C3, and acquires the read image data (step C4).

Next, the controller 21 determines, based on the read image data acquired in step C4, whether or not there is an air bubble between the film F and the sheet in the laminated sheet (step C5).

When there is no air bubble between the film F and the sheet (step C5; NO), the controller 21 ends the lamination control processing.

On the other hand, when there is an air bubble between the film F and the sheet (step C5; YES), the controller 21 updates the sheet conveyance speed in the lamination processing section 26 stored in the conveyance speed table 221 by adjustment (step C6), and ends the lamination control processing. In other words, the controller 21 adjusts the sheet conveyance speed in the lamination processing section 26 based on the result of the lamination.

In step C6, when there is an air bubble between the film F and the sheet, the controller 21 makes the sheet conveyance speed in the lamination processing section 26 lower than the currently set speed.

FIG. 7 illustrates an example of a conveyance speed table 221 that stores sheet conveyance speeds in the lamination processing section 26 after adjustment.

In the example illustrated in FIG. 7, the value of the sheet conveyance speed in the lamination processing section 26 indicates that the value is lower as the value is closer to the VO, and the value is higher as the value is closer to the V5.

### 4. EFFECT

As described above, the laminating device 20 according to the present embodiment includes the lamination processing section 26 that laminates the film F onto the recording medium having the image formed thereon.

The laminating device 20 according to the present embodiment includes an acquisition section (controller 21) that acquires sheet characteristic information corresponding to the smoothness of the recording medium.

The laminating device 20 according to the present embodiment includes a first controller (controller 21) that controls the conveyance speed in the lamination processing section 26 based on the sheet characteristic information acquired by the acquisition section.

Therefore, since the lamination processing can be performed at the sheet conveyance speed set according to the sheet characteristic information, it is possible to suppress a problem such as entry of air bubble between the film F and the sheet.

Thus, the laminating process can be performed with high quality.

In the laminating device 20 according to the present embodiment, the first controller (controller 21) controls the conveyance speed in the lamination processing section 26 to be lower as the smoothness of the recording medium indicated by the sheet characteristic information is lower.

Therefore, even in a case where the surface of the sheet is relatively rough, it is possible to suppress a problem such as entry of air bubble between the film F and the sheet by setting the conveyance speed in the lamination processing section 26 to be relatively low.

The laminating device 20 according to the present embodiment includes the storage section 22 that stores the conveyance speed in the lamination processing section 26 set in accordance with the sheet characteristic information.

The first controller (controller 21) sets the conveyance speed in the lamination processing section 26 to the conveyance speed stored in the storage section 22.

Therefore, the conveyance speed in the lamination processing section 26 can be easily set by the conveyance speed table 221.

In the laminating device 20 according to the present embodiment, the acquisition section (controller 21) acquires the detection result of the smoothness sensor 17 that detects the smoothness of the recording medium as the sheet characteristic information.

Therefore, the sheet characteristic information can be easily acquired.

In the laminating device 20 according to the present embodiment, the first controller (controller 21) adjusts the conveyance speed in the lamination processing section 26 based on the result of the lamination.

Therefore, the conveyance speed in the lamination processing section 26 can be set to a speed at which no problem occurs in the lamination.

In the laminating device 20 according to the present embodiment, the first controller (the controller 21) acquires a read image obtained by reading a laminated recording medium as a result of lamination processing.

Therefore, the result of the lamination processing can be easily determined based on the read image obtained by reading the laminated sheet.

The image forming system 1 according to the present embodiment includes the laminating device 20.

The image forming system 1 according to the present embodiment includes the image forming section 13 that forms an image on a recording medium.

The image forming system 1 according to the present embodiment includes the second controller (controller 11) which, when the conveyance speed in the lamination processing section 26 is lower than the conveyance speed in the image forming section 13, sets the conveyance speed in the image forming section 13 to the same speed as the conveyance speed in the lamination processing section 26.

Therefore, it is possible to suppress a failure in sheet conveyance which occurs due to a difference between the sheet conveyance speed of the image forming section 13 and the sheet conveyance speed of the lamination processing section 26.

The image forming system 1 according to the present embodiment includes the laminating device 20.

The image forming system 1 according to the present embodiment includes the image forming section 13 that forms an image on a recording medium.

The image forming system 1 according to the present embodiment includes the second controller (controller 11) which, when the conveyance speed in the lamination processing section 26 is lower than the conveyance speed in the image forming section 13, widens the conveyance interval of recording medium in the image forming section 13.

Therefore, it is possible to suppress a failure in sheet conveyance which occurs due to a difference between the sheet conveyance speed of the image forming section 13 and the sheet conveyance speed of the lamination processing section 26.

Although specific description has been given above based on the embodiment according to the present disclosure, the present disclosure is not limited to the above-described embodiment, and changes can be made without departing from the spirit and scope of the present disclosure.

For example, in the above-described embodiment, the lamination processing is performed on one surface of the sheet, but the present invention is not limited thereto. The laminating process may be performed not only on the entire surface of one side of the sheet but also on a part of the surface, or may be performed not only on one side but also on both sides.

In the above-described embodiment, an optional configuration in which the laminating device 20 is attached separately from the image forming apparatus 10 is adopted, but the present invention is not limited thereto. For example, the image forming apparatus 10 may include the laminating device 20.

Although the controller 21 of the laminating device 20 executes the lamination control processing in the above embodiment, it is not limited thereto. The controller 11 of the image forming apparatus 10 or a controller of an external device communicably connected to the laminating device 20 may execute the lamination control processing.

Although the image forming section 13 forms an image by an electrophotographic method in the above embodiment, it may form an image by an inkjet method.

In the above-described embodiment, the sheet characteristic information is detected by the smoothness sensor 17, and the controller 21 acquires the detection result, but the invention is not limited thereto. The controller 21 may acquire the sheet characteristic information corresponding to the smoothness of the sheet preset in the print job. Alternatively, the controller 21 may obtain the sheet characteristic information corresponding to the smoothness of the sheet according to an input by the user through the operation part 152.

In addition, the detailed configuration of each device constituting the image forming apparatus and the detailed operation of each device can also be appropriately modified without departing from the spirit and scope of the present disclosure.

Although embodiments of the present invention have been described and illustrated in detail, the disclosed embodiments are made for purposes of illustration and example only and not limitation. The scope of the present invention should be interpreted by terms of the appended claims.

What is claimed is:

1. A laminating device comprising:
a laminator that performs lamination processing of laminating a film on a recording medium on which image formation has been performed; and
a first hardware processor that:
acquires sheet characteristic information corresponding to smoothness of the recording medium; and
controls a conveyance speed in the laminator based on the acquired sheet characteristic information.

2. The laminating device according to claim 1, wherein
the first hardware processor controls the conveyance speed to be lower as the smoothness of the recording medium indicated by the sheet characteristic information is lower.

3. The laminating device according to claim 1, further comprising
a storage configured to store the conveyance speed set in accordance with the sheet characteristic information, wherein
the first hardware processor sets the conveyance speed in the laminator to the conveyance speed stored in the storage.

4. The laminating device according to claim 1, wherein
the first hardware processor acquires, as the sheet characteristic information, a detection result of a smoothness sensor that detects the smoothness of the recording medium.

5. The laminating device according to claim 1, wherein
the first hardware processor adjusts the conveyance speed based on a result of the lamination processing.

6. The laminating device according to claim 5, wherein
the first hardware processor acquires a read image obtained by reading the laminated recording medium as the result of the lamination processing.

7. An image forming system comprising:
the laminating device according to claim 1;
an image former that forms an image on the recording medium; and
a second hardware processor that sets a conveyance speed in the image former to the same speed as the conveyance speed in the laminator when the conveyance speed in the laminator is lower than the conveyance speed in the image former.

8. An image forming system comprising:
the laminating device according to claim 1;
an image former that forms an image on the recording medium; and
a second hardware processor that widens a conveyance interval of the recording medium in the image former when the conveyance speed in the laminator is lower than a conveyance speed in the image former.

9. A non-transitory storage medium storing a computer-readable program for a computer of a laminating device including a laminator that performs lamination processing of laminating a film on a recording medium on which image formation has been performed, the program causing the computer to perform:
acquiring sheet characteristic information corresponding to smoothness of the recording medium; and
controlling a conveyance speed in the laminator based on the acquired sheet characteristic information.
